(19) United States
(12) Patent Application Publication
(10) Pub. No.: US 2015/0379441 A1
(43) Pub. Date: Dec. 31, 2015

(54) SHARED ASSET MANAGEMENT SYSTEM

(71) Applicant: EBAY INC., San Jose, CA (US)

(72) Inventors: Mobeen Syed, San Jose, CA (US); Sandy Lynn Godsey, San Jose, CA (US)

(21) Appl. No.: 14/319,923

(22) Filed: Jun. 30, 2014

(51) Int. Cl. G06Q 10/06; G06F 19/00

(52) U.S. Cl. CPC G06Q 10/0631; G06F 19/327; G06F 19/3412

(57) ABSTRACT

Systems and methods for managing shared assets include receiving, by a system provider device through at least one beacon device, first location information for a managed shared asset. The first location information is collected from a beacon communication device that is associated with the managed shared asset. The system provider device uses an identity of the managed shared asset and the first location information to determine first shared asset management information from a plurality of shared asset management information that is stored in a database. The system provider device then transmits the first shared asset management information over a network. The first shared asset management information is configured to provide at least one management action on the managed shared asset. In specific embodiments, the managed shared assets are managed hospital assets in a physical hospital location such as hospital patients, hospital equipment, and hospital staff.

### BACKGROUND

1. Field of the Invention

The present disclosure generally relates to asset management for shared assets, and more particularly to a system that provides for improved management functionality for shared assets such as those in a medical environment that may include hospital patients, hospital equipment, and hospital staff.

2. Related Art

In systems and environments where equipment and assets are shared among a variety of users, a variety of methods are implemented for maintaining, identifying, locating and managing these shared assets. These systems are conventionally manual, including the use of paper recording, or by manual data entry on electronic storage by an attendant. Accurate asset management is critical for proper operation of a business; in some businesses this criticality extends to human care and places a heavier burden on the management system. A hospital system is described herein as an example use of the shared asset management system and method of the present disclosure that remedies the deficiencies of such conventional systems.

Conventional hospital care depends on the management of hospital subsystems, including staff management subsystems, equipment management subsystems, patient management subsystems, and/or a variety of other hospital management subsystems known in the art. Many of these conventional management subsystems suffer from issues that can affect patient care. For example, conventional equipment management subsystems are often deficient in tracking and reporting the location of equipment in the hospital, which can result in equipment not being available to treat patients when it is needed. Similarly, conventional patient management subsystems are often deficient in tracking and reporting the location of patients in the hospital, which can result in inefficiencies in treating patients and incorrect treatment and/or procedure delivery. Furthermore, conventional hospital management subsystems typically fail to share their management information with other hospital management subsystems and/or fail to incorporate management information from other hospital management subsystems, and thus do not realize benefits that can be achieved through a more comprehensive view of the management information generated in the hospital.

Thus, there is a need for an improved hospital asset management system.

### BRIEF DESCRIPTION OF THE FIGURES

FIG. 1 is a schematic view illustrating an embodiment of a physical hospital location;

FIG. 2 is a schematic view illustrating an embodiment of a beacon device;

FIG. 3a is a schematic view illustrating an embodiment of a plurality of the beacon devices of FIG. 2 located in the physical hospital location of FIG. 1 to provide a beacon system;

FIG. 3b is a schematic view illustrating an embodiment of the beacon system of FIG. 3a providing a portion of a hospital asset management system;

FIG. 4 is a schematic view illustrating an embodiment of a hospital asset management system;

FIG. 5 is a flow chart illustrating an embodiment of a method for hospital management;

FIG. 6 is a perspective view illustrating an embodiment of a hospital bed;

FIG. 7 is a perspective view illustrating an embodiment of a patient and hospital staff;

FIG. 8a is a screen shot illustrating an embodiment of a user device displaying a management action;

FIG. 8b is a screen shot illustrating an embodiment of a user device displaying a management action;

FIG. 8c is a screen shot illustrating an embodiment of a user device displaying a management action;

FIG. 8d is a screen shot illustrating an embodiment of a user device displaying a management action;

FIG. 8e is a screen shot illustrating an embodiment of a user device displaying a management action;

FIG. 8f is a screen shot illustrating an embodiment of a user device displaying a management action;

FIG. 8g is a screen shot illustrating an embodiment of a user device displaying a management action;

FIG. 9 is a schematic view illustrating an embodiment of a networked system;

FIG. 10 is a perspective view illustrating an embodiment of a user device;

FIG. 11 is a schematic view illustrating an embodiment of a computer system; and

FIG. 12 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for shared asset management that may include a wireless control system that communicates with distributed communication devices that are included in, attached to, or otherwise provided with shared assets, such as the hospital equipment, hospital patients, hospital staff, and/or other managed hospital assets discussed below. The communication between the wireless control system, such as the beacon system discussed below, and the distributed communication devices, such as beacon communication devices discussed below, allows for the locations of the managed assets in and around the hospital to be determined, which provides the ability to quickly and easily determine where managed assets are located, if managed assets are not in a preferred or predetermined location, the ability to group different managed assets according to grouping rules or grouping preferences, and a variety of other benefits that will be apparent to one of skill in the art in possession of the present disclosure. Furthermore, the communication between the wireless system and the distributed communication devices allows for the control of managed assets, the configuring of managed assets for use with other managed assets, the assigning of managed assets to other managed assets (e.g., the assignment of hospital staff to hospital patients), and/or the provision of a variety of other benefits that are discussed below. Furthermore, other scenarios are considered where assets are shared among participants, whom may have different access and control functions with respect to those assets, which may be managed by the shared asset management system. For example, where a variety of devices have communication capabilities, as in the Internet of Things (IoT), the ability to manage shared assets in an efficient way benefits from the management methods discussed herein.

In a specific embodiment described in detail in the examples below, the present disclosure provides systems and methods for hospital asset management that utilize a beacon system at a hospital that communicates with beacon communication devices that are included in, attached to, or otherwise provided with managed hospital assets such as hospital equipment, hospital patients, hospital staff, and/or a variety of other managed hospital assets known in the art. The communication between the beacon system and the beacon communication devices allows for the locations of the managed assets in and around the hospital to be determined, which provides the ability to quickly and easily determine where managed assets are located, if managed assets are not in a preferred or predetermined location, the ability to group different managed assets according to grouping rules or grouping preferences, and a variety of other benefits that will be apparent to one of skill in the art in possession of the present disclosure. Furthermore, the communication between the beacon system and the beacon communication devices allows for the control of managed assets (e.g., the enabling or disabling of hospital equipment), the configuring of managed assets for use with other managed assets (e.g., the configuring of a hospital bed for a particular patient), the assigning of managed assets to other managed assets (e.g., the assignment of hospital staff to hospital patients), and/or the provision of a variety of other benefits that are discussed below. While the embodiments discussed below are directed to human patients at a hospital, the systems and methods discussed herein will provide similar benefits to animal hospitals or veterinarian locations that treat animal patients, and one of skill in the art will recognize that the application of the teachings of the present disclosure to such embodiments will fall within its scope. As such, the term “patient” discussed below may refer to humans or animals, and the term “hospital” may refer to any physical location where humans or animals are treated for physical, mental, or other ailments.

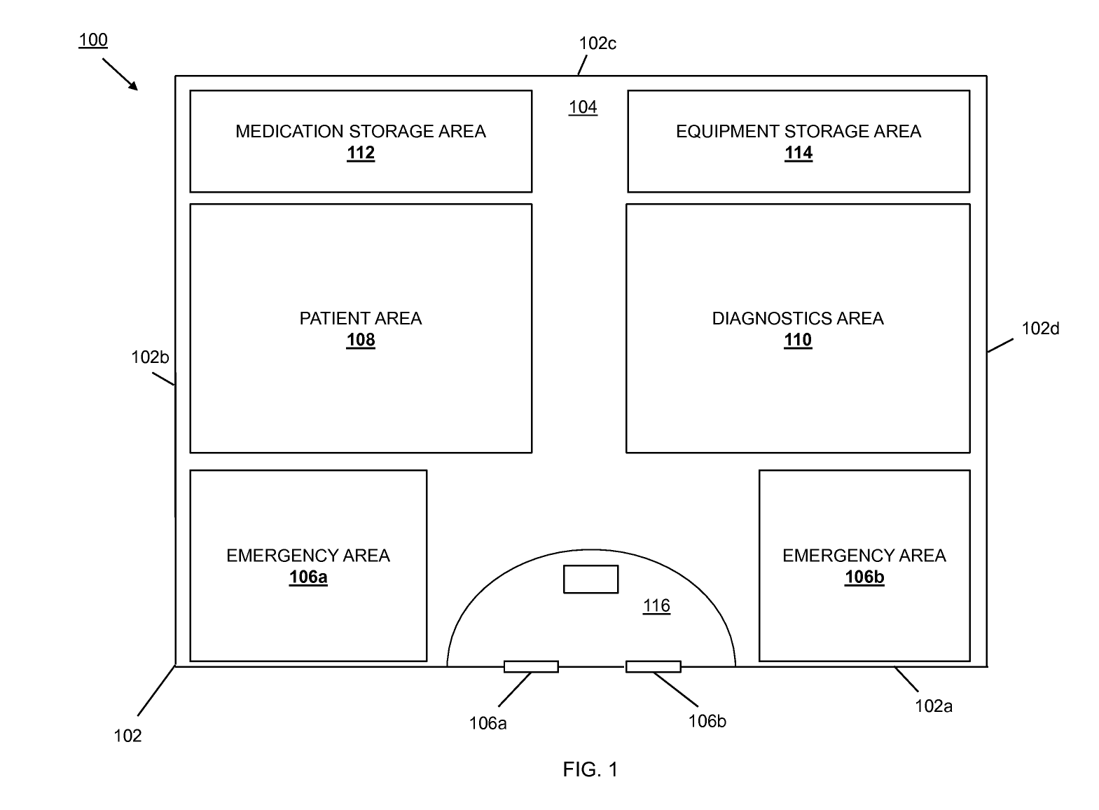

Referring now to FIG. 1, an embodiment of a physical hospital location 100 is illustrated. The physical hospital location 100 includes a hospital building 102 having a plurality of exterior walls 102a, 102b, 102c, and 102d that define a physical hospital location interior 104 that, in the embodiments illustrated and discussed below, is a general hospital. However, one of skill in the art in possession of the present disclosure will recognize that the hospital asset management systems and methods described herein may be utilized with virtually any physical hospital location such as, for example, district hospitals, specialized hospitals, teaching hospitals, clinic hospitals, private doctors offices, and/or a variety other physical hospital locations known in the art. The exterior wall 102a includes pair of exterior doors 106a and 106b (e.g., “front” doors in the illustrated embodiment).

In an embodiment, the physical hospital location interior 104 of the physical hospital location 100 includes a plurality of hospital areas. In the embodiments discussed below the physical hospital location 100 is a general hospital and the physical hospital location interior 104 includes a plurality of emergency areas 106a and 106b, a patient area 108, a diagnostics area 110, a medication storage area 112, an equipment storage area 114. While a few examples for a physical hospital location have been provided, one of skill in the art will recognize that any variety of different areas in any physical hospital location 100 will fall within the scope of the present disclosure. The physical hospital location interior 104 also includes a lobby area 116, hallways between the different areas, and/or other hospital features known in the art. While the physical hospital location 100 is illustrated as including a single floor of a single building, one of skill in the art will recognize that physical hospital locations may include several building with one or more floors, and such physical hospital locations will fall within the scope of the present disclosure.

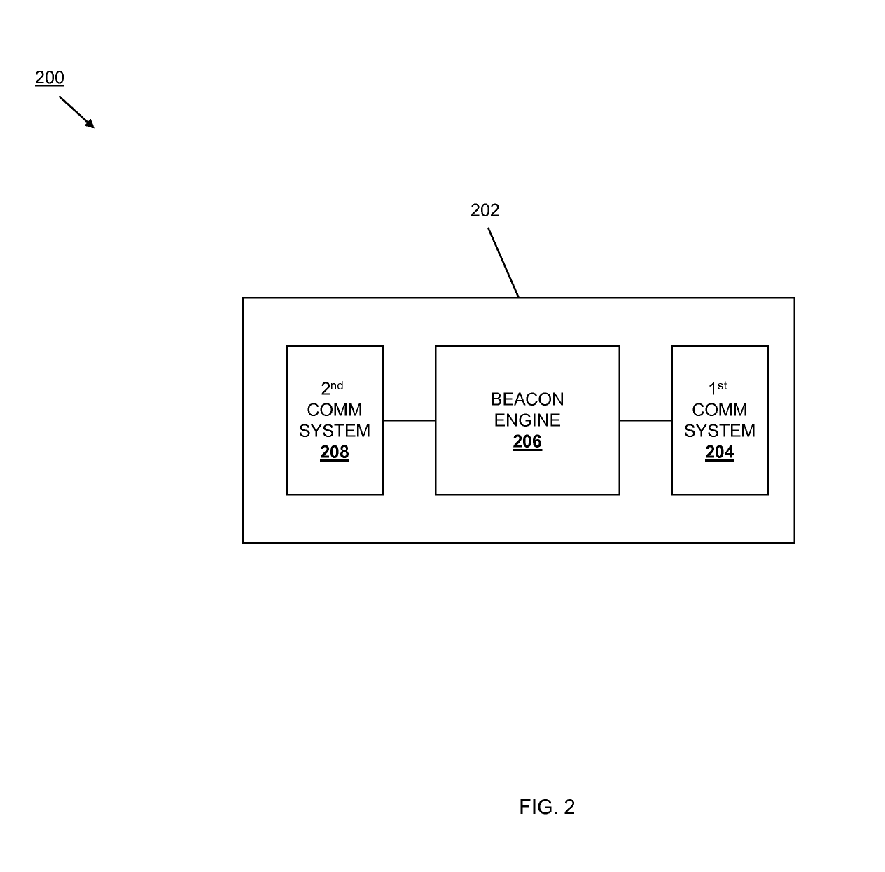

Referring now to FIG. 2, an embodiment of a beacon device 200 is illustrated. The beacon device 200 includes a chassis that houses a first communications system 204 such as, for example, a Wifi communications system, a cellular communication system, and/or a variety of other communication systems known in the art. The first communications system 204 is coupled to a beacon engine 206 that may be provided by instructions on a memory system (not illustrated) in the beacon device 200 that, when executed by a processing system (not illustrated) in the beacon device 200, cause the processing system to perform the functions of the beacon device 200 discussed below. The beacon engine 206 is coupled to a second communication system 208 such as, for example, a Bluetooth® Low Energy (BLE) communication system, a BLE direct communication system, a Wifi direct communication system, a near field communication (NFC) system, and/or a variety of other communication systems known in the art. In some of the embodiments discussed below, the beacon engine 206 may be configured to receive any of a variety of sensor signals through the second communication system 208 and transmit those sensor signals using the first communication system 204. While a few examples of communications components in the beacon device 200 have been described, one of skill in the art will recognize that other communications devices, as well as other components that have been omitted for clarity of discussion and illustrated, may be included in the beacon device 200 and will fall within the scope of the present disclosure. One of skill in the art will recognize that the components described above allow for the beacon device to be provided in a relatively small form factor such that it may be placed inconspicuously almost anywhere. As such, the chassis 202 of the beacon device 200 may include any of a variety of features that allow for the coupling of the beacon device to any part of a physical hospital location 100, discussed below.

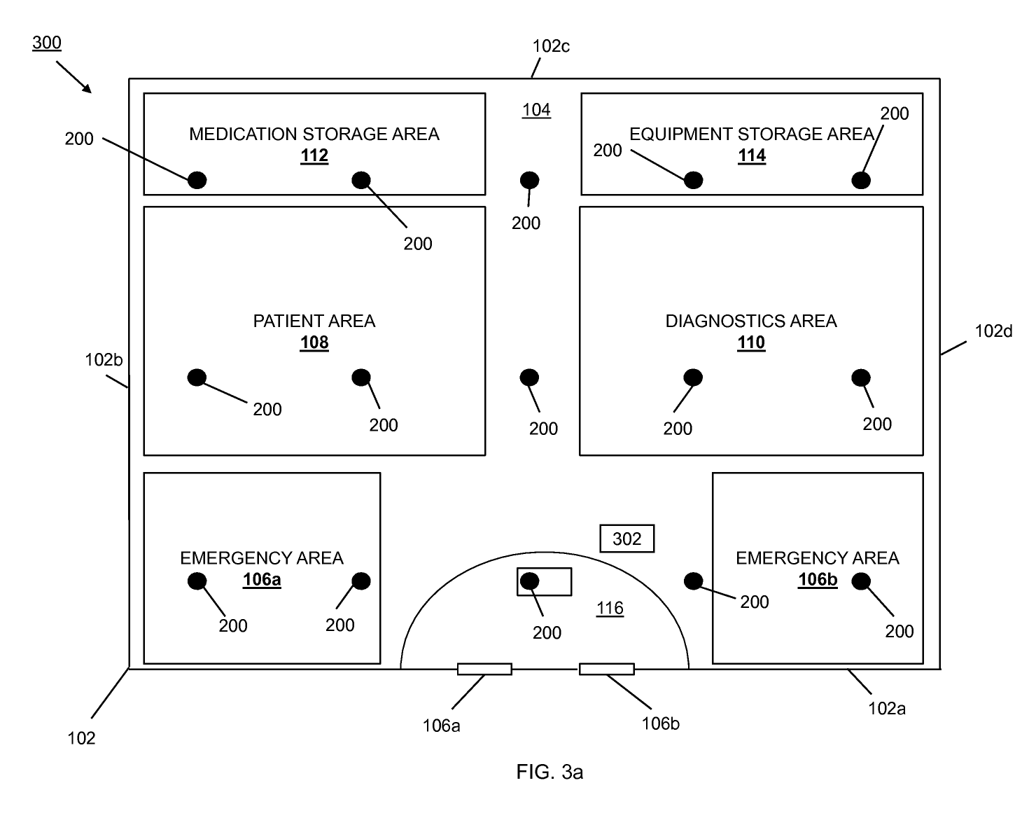

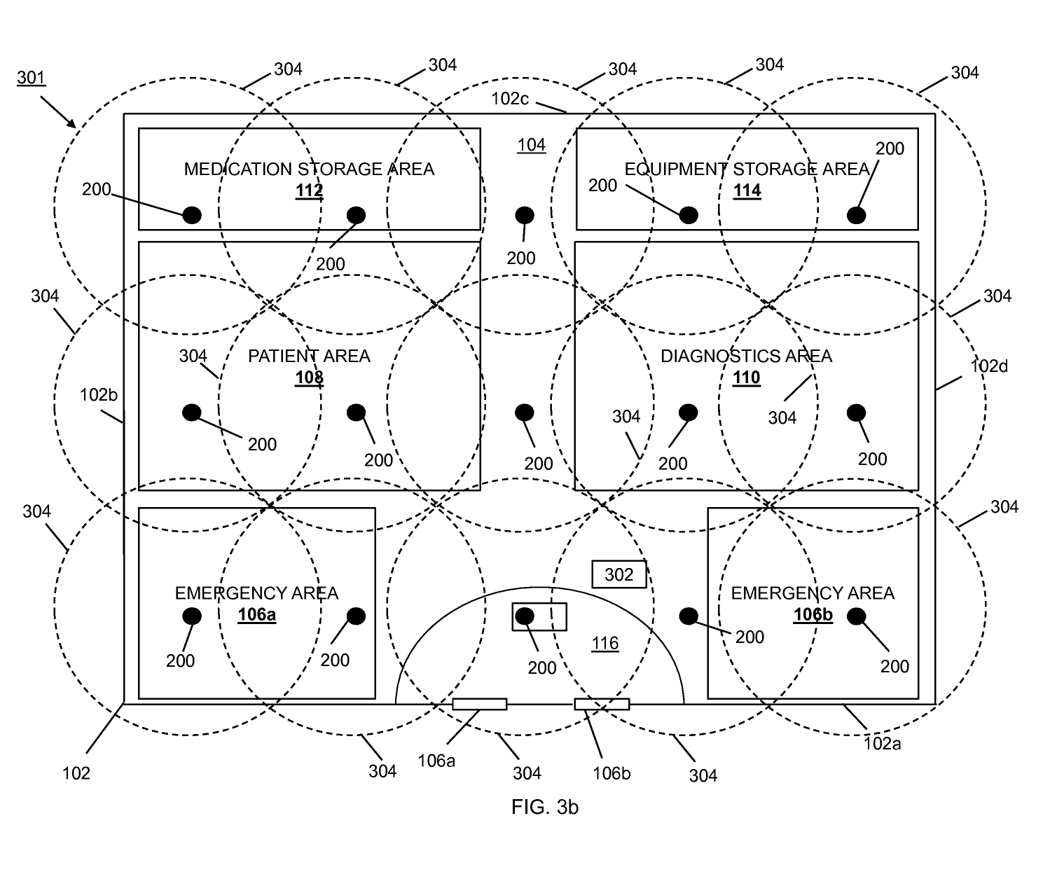

Referring now to FIGS. 3a and 3b, an embodiment of a beacon system 300 providing a portion 301 of a hospital asset management system is illustrated. As illustrated in FIG. 3a, the beacon system 300 is provided by positioning a plurality of the beacon devices 200, discussed above with reference to FIG. 2, in and around the physical hospital location 100, discussed above with reference to FIG. 1. As discussed above, the beacon devices 200 may be sized and/or include features such that they may be inconspicuously positioned virtually anywhere in or around the physical hospital location 100. For example, the beacon devices 200 may be positioned on the ceiling of the physical hospital location interior 104, on the shelving in the different areas in the physical hospital location 100, on desktops in the lobby area 116, and/or in any other part of the physical hospital location 100. Each of the beacon devices 200 in the beacon system 300 may be configured to wirelessly communicate, via its first communications system 204, with a network communication device 302 such as, for example, a Wifi wireless router connected to a network such as the Internet, a computing device connected to a Local Area Network (LAN), and/or a variety of other network communication devices known in the art.

Referring now to FIG. 3b, in operation, each of the beacon devices 200 in the beacon system 300 is configured to create a communication area 304 with its second communications system 204 to provide the portion 301 of the hospital asset management system. For example, the second communications system 204 in each beacon device 200 may be BLE communications device that provides an approximately 100 foot radius communications area. However, other communications systems providing other communications areas are envisioned as falling within the scope of the present disclosure. As can be seen in the illustrated embodiment, the beacon devices 200 may be positioned in and around the physical hospital location 100 such that the communications areas 304 abut, overlap, or otherwise provide coverage for any area of interest within and around the physical hospital location 100. As such, one of skill in the art in possession of the present disclosure will appreciate that different configurations of the beacon devices 200 within and around the physical hospital location 100 may be selected to cover any area within and around the physical hospital location 100 with a communications area 304. As discussed in further detail below, each of the beacon devices 200 are configured to communicate with beacon communication devices and/or user devices within their respective communications area 304 (e.g., using the second communication system 208) to collect information, and then send that information to the network communication device 302 (e.g., using the first communication system 204) such that the data may be provided to a hospital computing device, a system provider device, and/or any other device operating to provide hospital asset management system discussed below.

In the embodiments illustrated and discussed below, the beacon devices 200 and their communications areas 304 are not illustrated for clarity, but it should be understood that the communications and retrieval of information from beacon communication devices and/or user devices, and the provision of that information to a system provider device, may be accomplished using beacon devices providing communications areas such as the beacon devices 200 and communications areas 304 illustrated in FIGS. 3a and 3b. While a specific example of a hospital asset management system is provided, one of skill in the art in possession of the present disclosure will recognize that a wide variety of different physical hospital location may incorporate the beacon devices 200 in a variety of manners while remaining within its scope.

In the embodiments discussed below, the hospital asset management systems and methods involve a system provider using a system provider device to retrieve information collected by the beacon devices 200 through a network (e.g., the Internet). In such embodiments, the system provider may associate the physical hospital location 100 (or its hospital), the beacon devices 200, beacon communication devices, hospital computing devices, and/or other components of the system with a hospital account in a database located in a non-transitory memory. As such, information received from the beacon devices and hospital computing devices may be associated with the hospital account in the database, and any results of the analysis of that information may be stored in association with that hospital account. In other embodiments, the system provider device may be a hospital device that is local to the physical hospital location 100 and that communicates with the beacon devices 200 using the network communication device 302.

In an embodiment, the operation of the hospital asset management system may include providing the system provider device a map of the physical hospital location 100 and the relative locations of the areas, preferred or predetermined locations of hospital equipment, staff information, patient information, and/or other managed asset information. For example, the dimensions, relative locations, subdivisions of, and/or other characteristics of the emergency areas 106a and 106b, the patient area 108, the diagnostics area 110, the medication storage area 112, and the equipment storage area 114, and/or any other feature or characteristic of the physical hospital location interior 104 may be provided to the system provider device. As discussed below, the provision of such information to the system provider device allows the system provider device to create and utilize a detailed map, layout, or other reproduction of the physical hospital location interior 104.

Furthermore, the preferred/predetermined positions/locations of managed assets in the physical hospital location interior 104 may also be provided to the system provider device. In one example, the preferred/predetermined positions/locations of managed assets may be provided by the hospital or a system provider by selecting areas on a map of the physical hospital location 100. In another example, beacon communication devices may be attached to each managed hospital asset, and those beacon communication devices may be configured to report an identity and, in some embodiments, a location for each managed hospital asset to the beacon devices 200 (e.g., using a communication systems such as the BLE communications system discussed above.) As discussed below, the provision of such information to the system provider device allows the system provider device to determine the current location of any managed asset in the physical hospital location interior 104. While a few examples of the provision of physical hospital location layout information and managed asset preferred/predetermined location information to the system provider device have been described, one of skill in the art in possession of the present disclosure will recognize that a wide variety of physical hospital location information, managed asset information, and information provisioning techniques will allow for the functionality of the system provider device discussed below, and thus will fall within the scope of the present disclosure.

Furthermore, FIGS. 1, 3a, and 3b illustrate a physical hospital location 100 that is a single building, and the beacon devices 200 are positioned to provide communications areas 304 that cover the interior of that single building, and outside sections in the front of that single building. However, beacon devices 200 may be positioned virtually anywhere to retrieve information associated with a physical hospital location. For example, the physical hospital location may be located adjacent to or associated with a parking lot, and beacon devices may be positioned around that parking lot, at the entrances or exits of that parking lot, and/or anywhere else relative to that parking lot in order to collect and send information from beacon communication devices and/or user devices to the system provider device. In another example, the physical hospital location may be located in a medical park, and beacon devices may be positioned around that medical park, at the entrances or exits of that medical park, and/or anywhere else relative to that medical park in order to collect and send information from the beacon communication devices and/or user devices to the system provider device. In some examples, the first communication system may be connected to Wifi networks available outside the physical hospital location in order to communicate collected information to a system provider device. In other examples, the first communication system may be a cellular communications system that allows the beacon devices to be positioned anywhere in range of a cellular communications tower, allowing beacon devices to be positioned in virtually any physical location when providing the hospital asset management system.

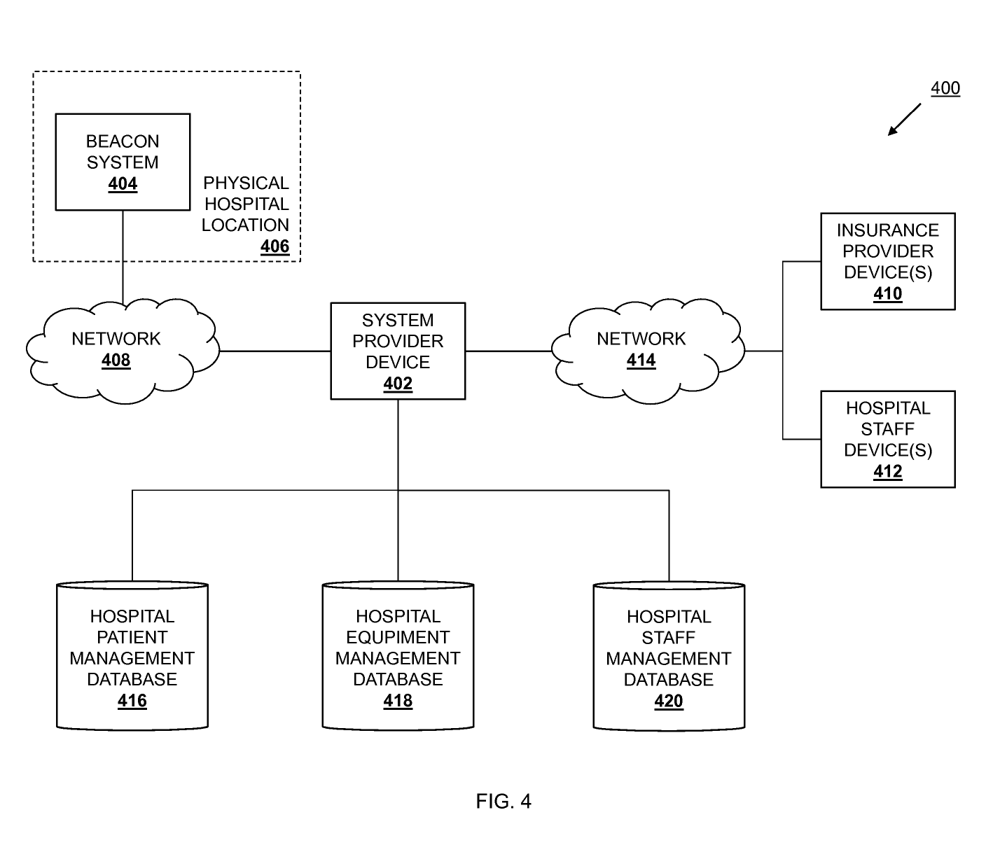

Referring now to FIG. 4, an embodiment of a hospital asset management system 400 is illustrated that may include the portion 301 of the hospital asset management system 301 discussed above with reference to FIG. 3b. The hospital asset management system 400 includes a system provider device 402 that in some embodiments may be operated by the hospital discussed above, and that in some embodiments may be operated by a system provider that is separate from the hospital (e.g., a system provider that provides hospital asset management for the hospital.) The system provider device is communicatively coupled to a beacon system 404 in the physical hospital location 406 by a network 408. In embodiments where the system provider device 402 is operated by a system provider that is separate from the hospital, the network 408 may be the Internet or another network that couples the beacon system 404 to the system provider device 402 that is located in a location that is separate from the physical hospital location 406. In embodiments where the system provider device 402 is operated by the hospital, the network 408 may be a LAN or other network that is local to the physical hospital location 406, and both the network 408 and the system provider device 402 may be located within the physical hospital location 406 (similarly as illustrated for the beacon system 404 in FIG. 4).

The system provider device 402 may also be coupled to one or more insurance providers device(s) 410, one or more hospital staff devices 412 (e.g., home computers of the hospital staff), and/or other devices discussed below through a network 414 such as, for example, the Internet. In addition, the system provider device 402 may be coupled to a plurality of databases such as, for example, the hospital patient management database 416, the hospital equipment management database 610, and the hospital staff management database 610 illustrated in FIG. 4. While illustrated as three separate database directly connected to the system provider device 402, the hospital patient database 416, the hospital equipment management database 610, the hospital staff management database 610, and any of the other databases discussed below, may be combined into fewer databases or separated into more database, and may be coupled to the system provider device over the networks 408 and 414.

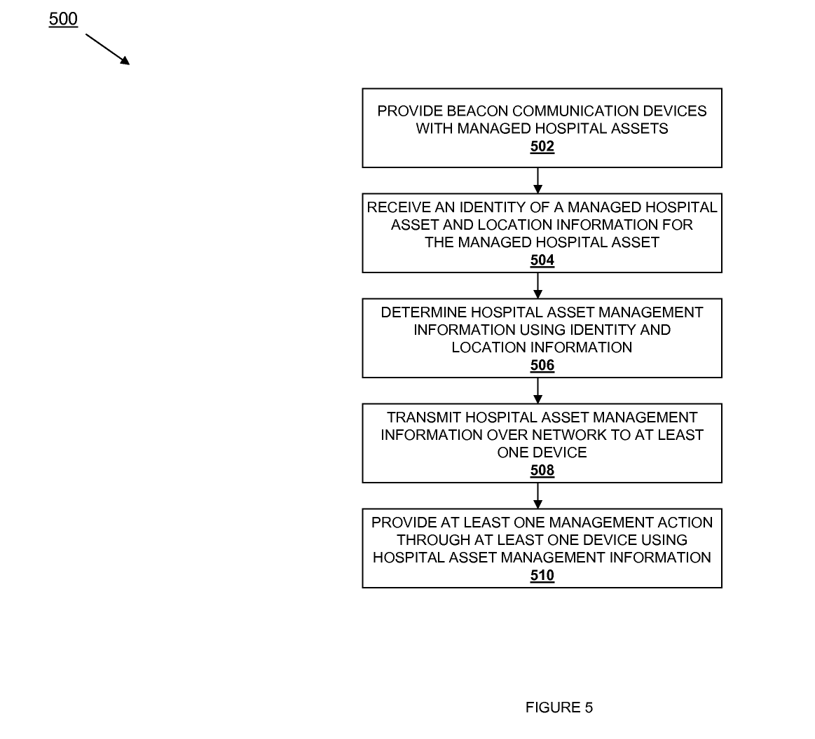

Referring now to FIG. 5, an embodiment of a method 500 for managing hospital assets is illustrated. As discussed below, the method 500 may be performed using the hospital asset management system 400 of FIG. 4 incorporating the portion 301 of the hospital asset management system illustrated in FIG. 3b. As such, references below to the hospital asset management system 400 may be directed to any part of the portion 301 of the hospital asset management system discussed above with reference to FIG. 3b even if element numbers from that portion 301 are not called out. For example, references to the physical hospital location 406 may include the physical hospital location 100, references to the beacon system 404 may include the beacon system 300, etc.

The method 500 begins at block 502 where beacon communication devices are provided with managed hospital assets. In an embodiment, managed hospital assets in the hospital asset management system 400 may include any asset of interest in the physical hospital location 406 such as, for example, hospital staff including doctors, nurses, administrative employees, and/or security employees; hospital patients including long-term patients, emergency room patients, future patients (e.g., waiting to be treated) and/or any other patients treated or to be treated at the physical hospital location 406; hospital equipment including hospital beds or other hospital furniture, medical equipment or other tools, patient files, medication containers, and/or a variety of other hospital equipment known in the art. In addition, managed hospital assets may include hospital visitors and/or any other person located in the physical hospital location 406. While a number of examples have been provided, those examples are not meant to be limiting and any assets located in or associated with the physical hospital location 406 will benefit from the asset management systems and methods described herein and are envisioned as falling within the scope of the present disclosure.

Beacon communication devices may be provided with the managed hospital assets discussed above at block 502 in a variety of manners. In some embodiments the second communication system 208 in the beacon devices 200 that provide the beacon system 404 may be BLE communication systems, and thus in those embodiments the beacon communication devices provided with the managed hospital assets at block 502 may include BLE communication systems as well. In addition, beacon communication devices may include a variety of different form factors that allow them to be provided with the managed hospital assets, a few examples of which are discussed below.

In some embodiments, beacon communication devices may be provided with hospital staff members by utilizing user devices of those hospital staff members such as, for example, their mobile phones, paging devices, or other wireless computing devices. For example, a hospital management application (or other application) may be provided on the user device of the hospital staff member, and that application may utilize a BLE communication system in the user device for communicating with the beacon system 404, discussed in further detail below. In another embodiment, beacon communication devices may be provided with hospital staff members by providing the hospital staff with wearable devices such as, for example, wristbands, name tags, clothing, etc., that incorporate beacon communication devices. For example, wristbands may be provided that include BLE communication systems for communicating with the beacon system 404, discussed in further detail below, and those wristbands may be provided to hospital staff members.

In some embodiments, beacon communication devices may be provided with hospital patients by utilizing user devices of the hospital patients such as, for example, their mobile phones. For example, a hospital management application (or other application) may be provided on the user device of the hospital patient, and that application may utilize a BLE communication system in the user device for communicating with the beacon system 404, discussed in further detail below. In another embodiment, beacon communication devices may be provided with hospital patients by providing the hospital patient with wearable devices such as, for example, wristbands, name tags, clothing, etc., that incorporate beacon communication devices. For example, patient gowns may be provided that include BLE communication systems for communicating with the beacon system 404, discussed in further detail below, and those patient gowns may be provided to patients.

In some embodiments, beacon communication devices may be provided with hospital equipment by attaching the beacon communication devices to the hospital equipment. For example, a beacon communication device may be adhered, attached, or otherwise coupled to a piece of hospital equipment, and that beacon communication device may include a BLE communication system for communicating with the beacon system 404, discussed in further detail below. In another embodiment, beacon communication devices may be integrated with hospital equipment by the hospital equipment manufacturer. For example, hospital equipment may be provided with a BLE communication system for communicating with the beacon system 404, discussed in further detail below.

While a few examples have been provided, one of skill in the art in possession of the present disclosure will recognize that a beacon communication device may be provided including a sticker, a clip, and/or a variety of other attachment features known in the art that will allow that beacon communication device to be attached to any managed hospital asset in the physical hospital location 406. Thus, user devices of managed hospital staff and patients may be repurposed as beacon communication devices, beacon communication device may be attached to managed hospital patients, staff, and/or equipment, and/or managed hospital equipment may include integrated beacon communication devices, that enable the performance of the method 500 discussed below.

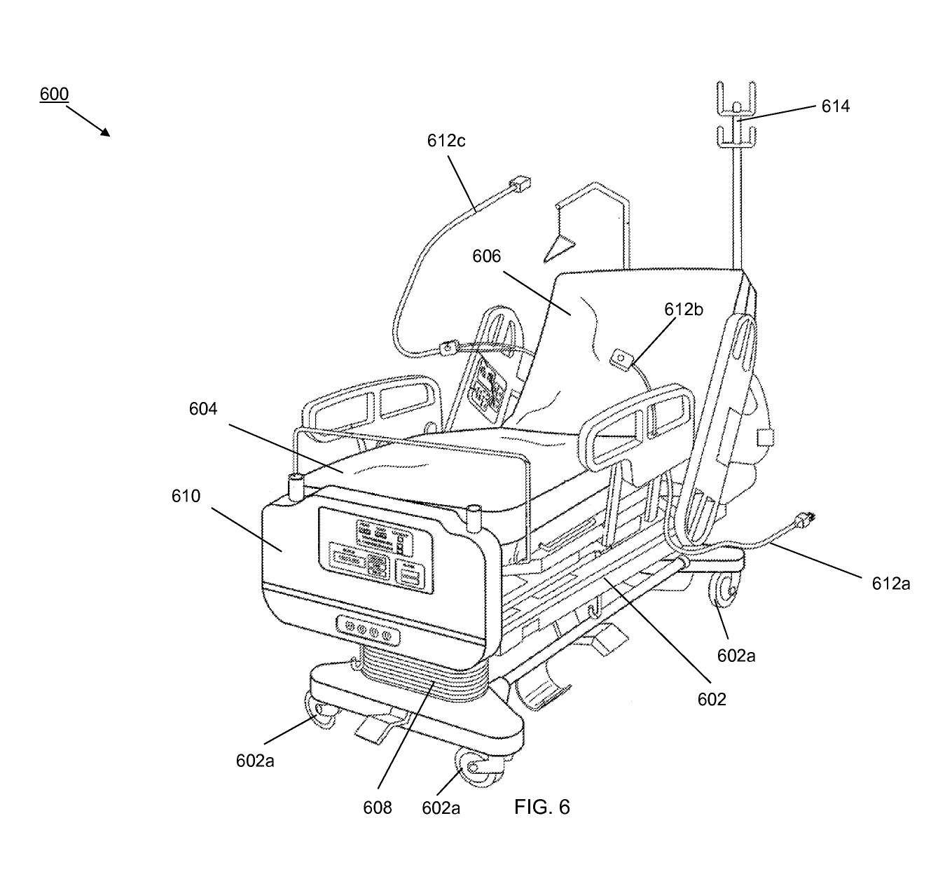

Referring to FIG. 6, an example of hospital equipment is provided that, in the illustrated embodiment, is a hospital bed 600. In the illustrated embodiment, the hospital bed 600 includes a frame 602 includes a plurality of wheels 602a. A base mattress portion 604 and an upper mattress portion 606 are supported by the frame 602 and may be moveably coupled to the frame 602 as discussed below. For example, a vertical movement system 608 may be provided between the frame 602 and the base mattress portion 604, as illustrated. A hospital bed computing system 610 is located on the frame 602 and may be coupled to any hospital bed equipment provided on the hospital bed 602. A plurality of equipment coupling devices 612a, 612b, and 612c are located on the frame 602, and an equipment support device 614 extends from the frame 602 above the upper mattress portion 606. As discussed above, the hospital bed 600 may include a beacon communication device that may be provided using the hospital bed computing system 610, or that may be attached, adhered, or otherwise coupled to the hospital bed 600. Furthermore, beacon communication devices may be provided on different features of the hospital bed 600 and/or on different equipment that is coupled to the hospital bed 600 (e.g., via the equipment coupling devices 612a, 612b, and 612c and/or the equipment support device 614). As discussed below, settings for the hospital bed 600 and a related patient may be stored in a database provided in the hospital bed computing system 610. Furthermore, the hospital bed computing system 610 may be configured to control features of the hospital bed 600 (e.g., the moveable base mattress portion 604, upper mattress portion 606, vertical movement system 608) and attached equipment as per the settings for the hospital bed 600 that are stored in the database.

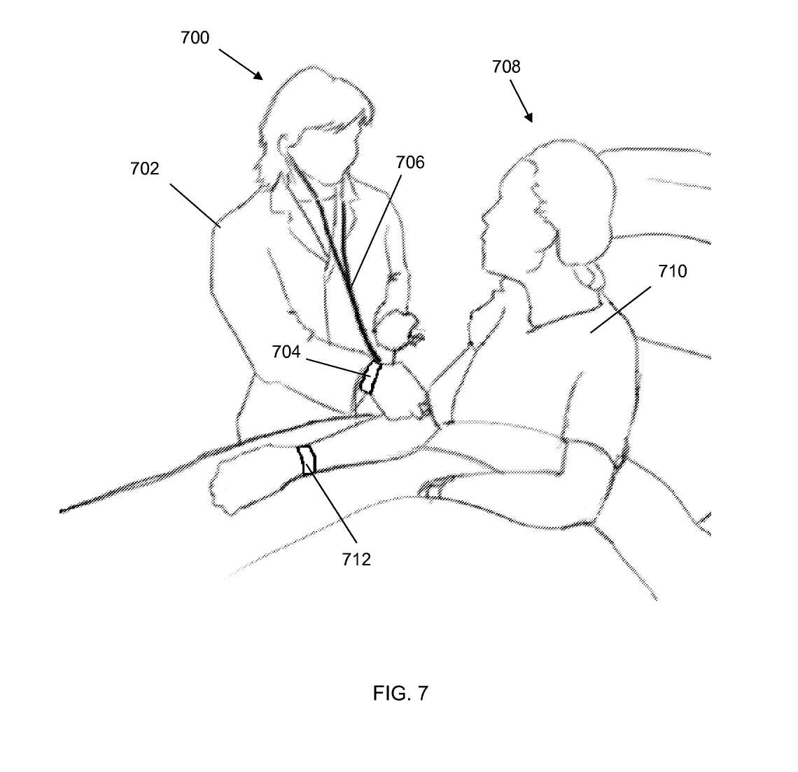

Referring to FIG. 7, an example of hospital staff and a hospital patient are provided that, in the illustrated embodiment, include a doctor 700 and a patient 708. In the illustrated embodiment, the doctor 700 may include any or all of hospital clothing 702 (e.g., the lab coat in the illustrated embodiment), a wearable device 704 (e.g., a wristband in the illustrated embodiment), and/or hospital equipment 706 (a stethoscope in the illustrated embodiment). In the illustrated embodiment, the patient 708 may include any or all of hospital clothing 710 (e.g., the gown in the illustrated embodiment) and/or a wearable device 712 (e.g., a wristband in the illustrated embodiment). As discussed above, a beacon communication device may be provided in any of the hospital clothing 702 and/or 710, the wearable device 704 and/or 712, and/or the hospital equipment 706.

As discussed above, the beacon communication devices provided with managed hospital assets at block 502 may be associated with those managed hospital assets in a database that may be accessible by the beacon system 404 and/or the system provider device 402. In an embodiment, with reference to FIG. 4, associations between the beacon communication devices provided with hospital patients may be stored in the hospital patient management database 416, associations between the beacon communication devices provided with hospital equipment may be stored in the hospital equipment management database 418, and associations between the beacon communication devices provided with hospital staff may be stored in the hospital staff management database 420. In one example, the associations between the beacon communication devices and managed hospital assets may be provided in databases that are local to the physical hospital location 406 and accessible by the beacon system 404. In another example, the associations between the beacon communication devices and managed hospital assets may be provided in the beacon communication devices themselves.

In some embodiments, the association between beacon communication devices and managed hospital assets may be provided using a management device that communicates with the beacon communication devices, the beacon system 404, and/or system provider device 402. For example, a user providing a beacon communication device with a managed hospital asset (e.g., adhering a beacon communication device to hospital equipment) may use a management device (e.g., a mobile phone with a hospital asset management application) to communicate the association between that beacon communication device and that managed hospital asset (e.g., via identification numbers provided with the beacon communication device and the managed hospital asset) to the beacon communication device, the beacon system 404, and/or system provider device 402. In some embodiments, the association between beacon communication devices and managed hospital assets may be provided by the beacon communication devices themselves that communicate with the beacon system 404 and/or system provider device 402. For example, a beacon communication device that is part of a user device of a managed hospital asset (e.g., hospital staff or patients) may retrieve a user identifier from the user device and communicate the association between that beacon communication device and that managed hospital asset (e.g., via the user identifier). While a few examples of the association of beacon communication devices and managed hospital assets in a database have been provided, one of skill in the art in possession of the present disclosure will recognize that the association of beacon communication devices and managed assets may be accomplished in a variety of manners while remaining with the scope of the present disclosure.

As such, following block 502, beacon communication devices are associated with the identities of managed hospital assets in database(s) accessible by the beacon system 404 and/or system provider device 402. In addition to associating the managed hospital assets with their beacon communication device in the database, a wide variety of other information may be retrieved and/or provided for association with the managed hospital asset in the database(s). In embodiments in which the managed hospital asset is hospital staff, information associated with it in the database may include a work schedule, an area of expertise, hospital patients for whom that hospital staff is responsible for, and/or a variety of other hospital staff-related information known in the art. Such information may be retrieved from other databases (e.g., over the Internet), determined through operation of the hospital asset management system 400 (e.g., repeated proximity of beacon communication devices on a doctor and a patient may indicate that doctor is responsible for that patient), and/or provided in the hospital staff database 420 in a variety of other manners known in the art.

In embodiments in which the managed hospital asset is a hospital patient, information associated with it in the database(s) may include details about a medical history of the patient, medications being used by the patient, allergies of the patient, a particular health issue currently being experienced by the patient, hospital staff providing care to the patient, visitors authorized to see the patient, and/or a variety of other hospital patient-related information known in the art. Such information may be retrieved from other databases (e.g., over the Internet), determined through operation of the hospital asset management system 400 (e.g., proximity of beacon communication devices on a patient and on a medication container may indicate that patient is using that medication), and/or provided in the hospital patient database 416 in a variety of other manners known in the art.

In embodiments in which the managed hospital asset is hospital equipment, information associated with it in the database(s) may include a preferred or predetermined location for the equipment, procedures that require the use of the equipment, patients with whom the equipment has been used, staff whom have used the equipment, and/or a variety of other hospital patient-related information known in the art. Such information may be retrieved from other databases, determined through operation of the hospital asset management system (e.g., proximity of beacon communication devices on a patient and a piece of equipment for a certain amount of time in a certain area may indicate that equipment has been used with that patient), and/or provided in the hospital equipment database 418 in a variety of other manners known in the art.

The method 500 may then proceed to block 504 where the identity of a managed hospital asset and first location information for that managed hospital asset are determined. In an embodiment of block 504, the beacon communication device provided with any managed hospital asset in the physical hospital location 406 may communicate with the beacon system 404, and that communication may then be provided by the beacon system 404 to the system provider device 402 over the network 408. In some examples, the communication of the beacon communication device with the beacon system 404 may include a beacon communication device identifier that is stored in a non-transitory memory of the beacon communication device. In some examples, the communication of the beacon communication device with the beacon system 404 may include a managed hospital asset identifier that is stored in a non-transitory memory of the beacon communication device.

In some embodiments, the beacon communication device may include a location determination device such as, for example, a Global Positioning System (GPS) device or other location determination devices known in the art, that is configured to determine a current location of the of the beacon communication device and communicate that current location to the beacon system 404. In some embodiments, the beacon system 404 may be configured to use the communication received from the beacon communication device to determine a current location of the beacon communication device utilizing, for example, triangulation techniques (e.g., via communications received by a plurality of beacon devices 200 in the beacon system 404) or other location determination techniques known in the art.

In some embodiments, the beacon system 404 may be configured to use a beacon communication device identifier received at block 504 to determine a managed hospital asset that is associated with that beacon communication device. For example, the beacon system 404 may use the beacon communication device identifier to reference a database that associates that beacon communication device identifier with a managed hospital asset. As such, the beacon system 404 may determine an identity of the managed hospital asset using the identity of the beacon communication device. In other embodiments, the beacon system 404 may receive a managed hospital asset identifier directly from the beacon communication device.

At block 504, the beacon system 404 then provides the identity of the managed hospital asset and the location information for the managed hospital asset to the system provider device. In some examples, the beacon system 404 may provide the identity of the managed hospital asset, as provided by the beacon communication device or determined by the beacon system 404 using the beacon communication device identifier as discussed above, over the network 408 to the system provider device 402. In some examples, the beacon system 404 may provide the beacon communication device identifier received from the beacon communication device similarly as discussed above, over the network 408 to the system provider device 402, and the system provider device 402 may use beacon communication device identifier to determine a managed hospital asset that is associated with that beacon communication device identifier in a database. For example, the system provider device 402 may use the beacon communication device identifier to reference the databases 416, 418, or 420 that associate that beacon communication device identifier with a managed hospital asset. As such, the system provider device 402 may determine an identity of the managed hospital asset using the identity of the beacon communication device.

Thus, following block 504, the system provider device 402 has received the identity of the managed hospital asset and location information for that managed hospital asset through the beacon system 404. A specific example of block 504 may include the system provider device 402 receiving an identity of a hospital staff member such as a doctor or a nurse from their beacon communication device, as well as location information for the hospital staff member that indicates the current location of that hospital staff member in the physical hospital location 406. Another specific example of block 504 may include the system provider device 402 receiving an identity of a hospital patient such as an emergency room patient or a long-term care patient from their beacon communication device, as well as location information for the hospital patient that indicates the current location of that hospital patient in the physical hospital location 406. Another specific example of block 504 may include the system provider device 402 receiving an identity of hospital equipment such as surgical equipment, a medication container, or a hospital bed from its beacon communication device, as well as location information for the hospital equipment that indicates the current location of that hospital equipment in the physical hospital location 406.

One of skill in the art in possession of the present disclosure will recognize that identities of any plurality of managed hospital assets in the physical hospital location 406 and location information describing their current locations in the physical hospital location 406 may be received at the same time or within a relatively short time period (e.g., 1 minute) through performance of the method 500. Beacon communication devices may be configured to regularly report the information discussed above to the beacon system 404 (e.g., on a predetermined time schedule, upon detecting movement of the beacon communication device (e.g., via an accelerometer in the beacon communication device), etc.), or to report the information discussed above to the beacon system 404 upon receiving a reporting instruction through the beacon system 404 (e.g., provided by a user of through the system provider device 402). Thus, the system provider device 402 may receive a respective identity and location for any plurality of managed hospital assets upon the performance of block 504 of the method 500.

The method 500 then proceeds to block 506 where hospital asset management information is determined using the identity of the managed hospital asset and the location information for the managed hospital asset. In an embodiment, the system provider device 402 may use the identity and current location of the managed hospital asset to determine hospital asset management information using, for example, information from one or more of the databases 416, 418, and 420. A number of examples of hospital asset management information are discussed below, but such examples are not meant to be limiting, and one of skill in the art in possession of the present disclosure will recognize that a wide variety of different hospital asset management information may be determined and used to provide instructions to perform management actions, discussed below, that will fall within the scope of the present disclosure.

In embodiments where the managed hospital asset is a hospital staff member, the hospital asset management information determined at block 506 may include instructions related to a hospital patient. For example, the managed hospital asset may be a doctor or a nurse, and the system provider device 402 may use the identity of that doctor or nurse to retrieve a list of patients associated with that doctor or nurse in the hospital staff management database 420. The system provider device 402 may then determine whether any of those patients requires the doctor or nurse (e.g., via an alert providing using conventional systems, an alert provided using the hospital asset management system 400, etc.) and, if so, include an alert in the hospital asset management information that informs the doctor or nurse about that patient. In some embodiments of this example, the current location of the patient may be retrieved using the techniques described herein and included as part of the hospital asset management information. In other embodiments, similar techniques may be used to report the location of any member of the hospital staff to a hospital staff tracking system that may be part of the system provider device 402.

In embodiments where the managed hospital asset is a hospital patient, the hospital asset management information determined at block 506 may include instructions related to a hospital staff. For example, the managed hospital asset may be an emergency room patient, and the system provider device 402 may use the identity of that patient or information about that patient's condition to retrieve a list of doctors or nurses associated with that patient or patient condition in the hospital patient management database 416 or the hospital staff management database 420. The system provider device 402 may then determine which of those doctors or nurse can treat that patient and include an alert in the hospital asset management information that informs those doctors or nurses about that patient. In some embodiments of this example, the current location of the doctors or nurses may be retrieved using the techniques described herein and included as part of the hospital asset management information. In other embodiments, similar techniques may be used to report the location of each hospital patient to a hospital patient tracking system that may be part of the system provider device 402. Such a hospital patient tracking system may include cost reduction rules to maximize the placement of patients by, for example, determining patient locations of multiple patients, and providing instructions to group patients in common areas in the physical hospital location 406 such that the number of hospital staff needed to treat such patients may be reduced.

In embodiments where the managed hospital asset is hospital equipment, the hospital asset management information determined at block 506 may include instructions related to a preferred or predetermined location of that hospital equipment. For example, the managed hospital asset may be surgical tool, and the system provider device 402 may use the identity of that surgical tool to retrieve a preferred or predetermined location for that surgical tool from the hospital equipment management database 418. The system provider device 402 may then determine whether that surgical tool is located in its preferred or predetermined location and, if not, include an instruction in the hospital asset management information that requests that the surgical tool be returned from its current location to its preferred or predetermined location.

In some embodiments, beacon communication devices may be configured to perform a similar function and report their “misplaced” location to the system provider device 402. For example, the beacon communication devices may be programmed with the preferred/predetermined location of the managed hospital asset that they are provided with and, upon determining (e.g., using a location determination device in the beacon communication device) that they are not in the preferred/predetermined location, may inform the system provider device 402 of their current location as well as their preferred/predetermined location. As such, relatively less critical equipment may be provided “dumb” beacon communication devices that simply report their identity and in some cases their location, while more critical equipment may be provided “smart” beacon communication devices that can determine if they are misplaced and report their current location as well as their preferred location. In other embodiments, similar techniques may be used to report the location of each piece of hospital equipment to a hospital equipment tracking system that may be part of the system provider device 402. Such a hospital equipment tracking system may include equipment use rules to maximize the use of hospital equipment by, for example, changing the preferred/predetermined location of hospital equipment based on a use schedule (e.g., a procedures schedule in one of the databases 416, 418, and/or 420) such that the equipment is moved throughout the physical hospital location 100 at different times to where it is needed.

As discussed above, in some embodiments the hospital asset management information may be determined using the identities and locations of multiple managed hospital assets. For example, the identity and location of a hospital patient may be received along with the identity and location of hospital equipment. The system provider device 402 may then determine from the proximity of the equipment and the patient whether the equipment is being used (or is co-located) with the patient and, if so, whether that equipment should be used (or be co-located) with that patient (e.g., by referencing information in the hospital patient management database 416 and in the hospital equipment management database 418). If the system provider device 402 determines that the equipment should not be used or co-located with that patient, the hospital management information may include an instruction to not use that equipment with that patient or remove that equipment from a room that includes that patient.

In another example, the identity and location of a first hospital patient may be received along with the identity and location of second hospital patient. The system provider device 402 may then determine from the proximity of the first patient and the second patient whether those patients are located together in a room, and whether those patients should be co-located (e.g., by referencing information in the hospital patient management database 416 such as patient histories, patient preferences, or other patient information). If the system provider device 402 determines that the patients should not be co-located, the hospital management information may include an instruction to move one of those patients such that the two are no longer co-located.

In another example, the identity and location of a hospital patient may be received along with the identity and location of a medication container. The system provider device 402 may then determine from the proximity of the medication container and the patient whether the patient is using the medication in the medication container and, if so, whether that patient should be using that medication (e.g., by referencing information in the hospital patient management database 416). If the system provider device 402 determines that the patient should not be using that medication, the hospital management information may include an alert to stop the patient from using that medication. In some embodiments, the system provider device 402 may use similar techniques to track how often a patient uses medication, and determine whether the patient is using too much of the medication. If the patient is determined to be using too much of the medication, the hospital management information may include an alert to stop the patient from using that medication.

In another example, the identity and location of a hospital patient may be received along with the identity and location of hospital bed. The system provider device 402 may then determine from the proximity of the hospital bed and the patient whether the hospital bed is being used with the patient and, if so, the system provider device 402 may retrieve the settings of that bed (e.g., preferred patient adjustments, attached hospital equipment, etc.) and store those settings (e.g., in the hospital patient management database 416 and/or in the hospital equipment management database 418). If the system provider device 402 then later determines that the patient has been moved to a different hospital bed (e.g., via communications with beacon communication devices on the patient and the different bed), the system provider device 402 may retrieve the settings for application to that different hospital bed. In some embodiments, the settings for the hospital bed that are related to the patient may be stored on the beacon communication device provided with the patient, and may be retrieved from that beacon communication device and used to provide the settings for the different hospital bed. As discussed, in some embodiments the hospital bed may be configured to automatically adjust based on those settings when the patient is detected as using the hospital bed.

In another example, the identity and location of a hospital patient and/or hospital staff may be received along with the identity and location of hospital equipment. The system provider device 402 may then determine the equipment is authorized for use with the patient or by the hospital staff. If the system provider device 402 determines that the equipment is authorized for use with that patient or by that hospital staff, the hospital management information may include an instruction to enable that equipment, while if the system provider device 402 determines that the equipment is not authorized for use with that patient or by that hospital staff, the hospital management information may include an instruction to disable that equipment. As such, a hospital equipment such as, for example, surgical equipment in an operating room, may be enabled or disable based on a procedure being performed on a patient (e.g., as retrieved from the hospital patient management database 416) or hospital staff authorized to use that equipment (as retrieved from the hospital staff management database 420).

In another example, the identity and location of a hospital patient may be received along with a procedure that has been suggested for that patient (e.g., via a use device of a doctor or nurse). The system provider device 402 may then determine an insurance provider of the patient (e.g., via the hospital patient management database 416) and connect to the insurance provider device 410 over the network 414. Upon connecting to the insurance provider device 410, the system provider device 402 may begin a real-time interface with the insurance provider device to determine the actual cost of the procedure (e.g., an “out-of-pocket” cost) to the patient, and the hospital management information may include that cost. In some embodiments, the system provider device 402 may also determine possible alternative procedures using procedure rules provided by the insurance provider device 410, and the hospital management information may include those alternative procedures as well as their associated cost.

In another example, a beacon communication device provided with a hospital patient may retrieve monitoring information from a patient monitor that monitors that patient, and the beacon communication device may report that information to the system provider device 402 along with the identity and location of the patient. The system provider device 402 may then determine a doctor associated with the patient (e.g., via the hospital patient management database 416 and/or hospital staff management database 420), and provided that monitoring information about the patient to that doctor. In some examples, the beacon communication device provided with the patient may monitor the patient's actions or activities and report those actions or activities to the system provider device 402 along with the identity and location of the patient. The system provider device 402 may then determine whether those actions or activities are indicative of a problem with the patient and, if so, inform a doctor, schedule an appointment with a doctor, and/or perform other actions that are designed to treat that problem.

Thus, just a few examples have been provided of the ways in which the identity, location, and/or other information about a managed hospital asset that is received from beacon communication devices may be utilized to determine hospital asset management information. As discussed above, one of skill in the art will recognize that different uses and combinations of uses, just a few or which are explicitly discussed herein, may be made of the information received from beacon communication devices and information stored in the databases 416, 418, and 420 in order to provide the hospital asset management information while remaining within the scope of the present disclosure.

The method 500 the proceeds to block 508 where the hospital asset management information is transmitted over a network to at least one device. In some embodiments, the hospital asset management information may be transmitted over the network 408 and/or 414 to user devices operated by hospital staff such as doctors, nurses, administrators, security, etc. In some embodiments, the hospital asset management information may be transmitted over the network 408 and/or 414 to user devices operated by hospital patients. In some embodiments, the hospital asset management information may be transmitted over the network 408 and/or 414 to user devices operated by any other entity that may carry out the management actions discussed below. In different embodiments, the determination of whom to transmit the hospital asset management information to may be made by the system provider device 402 based on information stored in the database 416, 418, and/or 420 that indicates which entities need the information, which entities requested the information, which entities can carry out the management actions provided, and/or a variety of other considerations.

The method 500 then proceeds to block 510 where at least one management action is provided through at least one user device using the hospital asset management information. Examples of management actions provided through user devices are provided below, but one of skill in the art will recognize that a wide variety of management actions may be provided through a wide variety of devices using the hospital asset management information discussed herein while remaining within the scope of the present disclosure. Thus, the user devices discussed below providing the management actions may be devices operated by hospital devices, personal devices operated by hospital staff (e.g., home computers of hospital staff), personal device operated by hospital patients, etc.

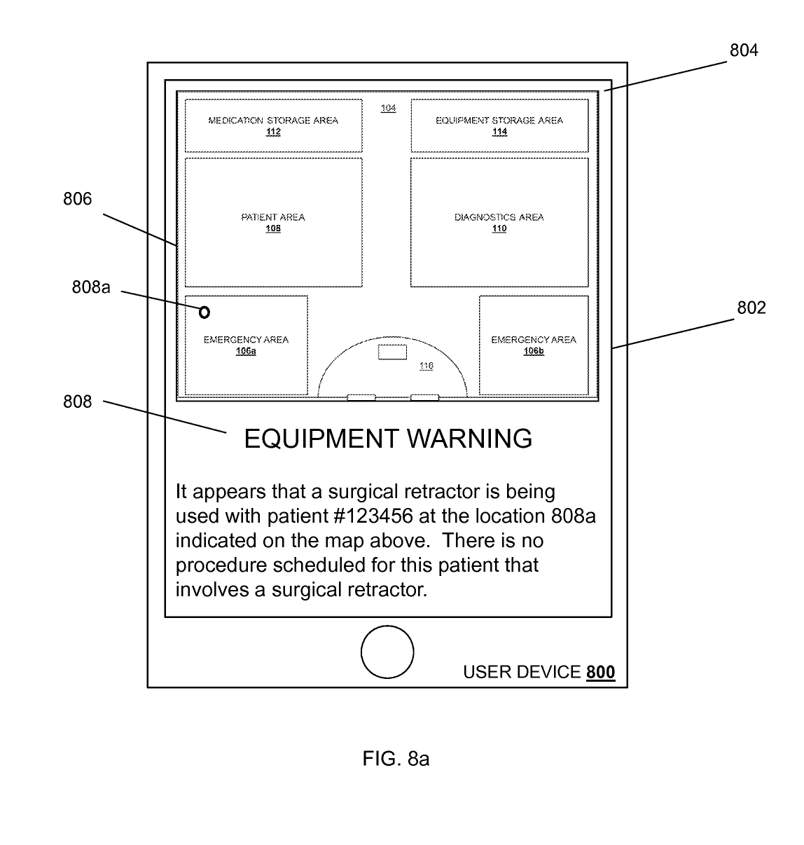

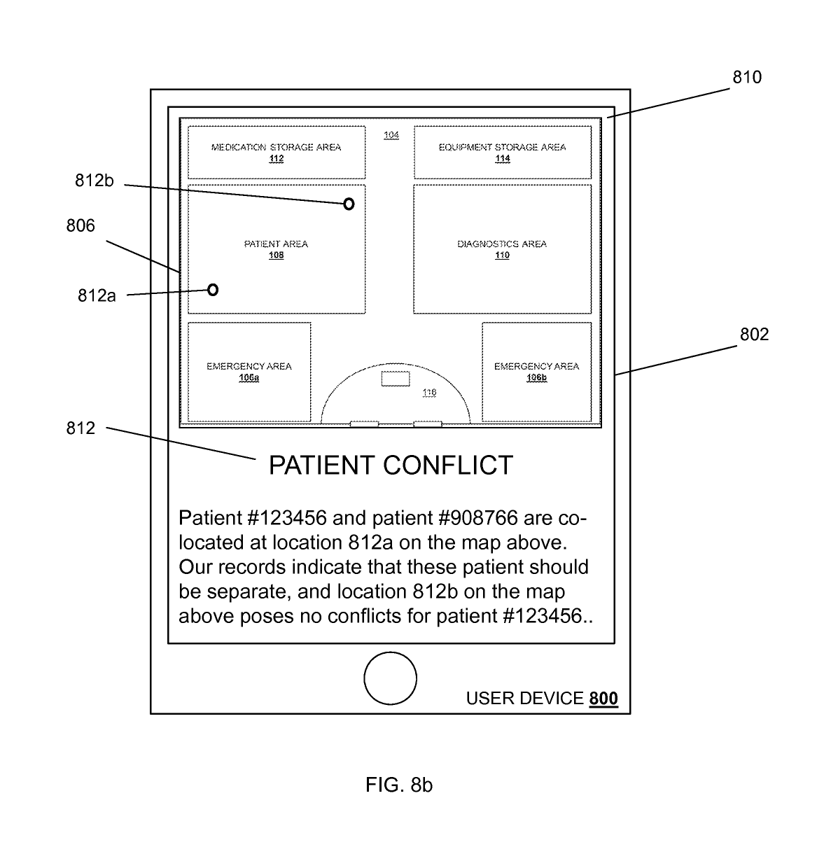

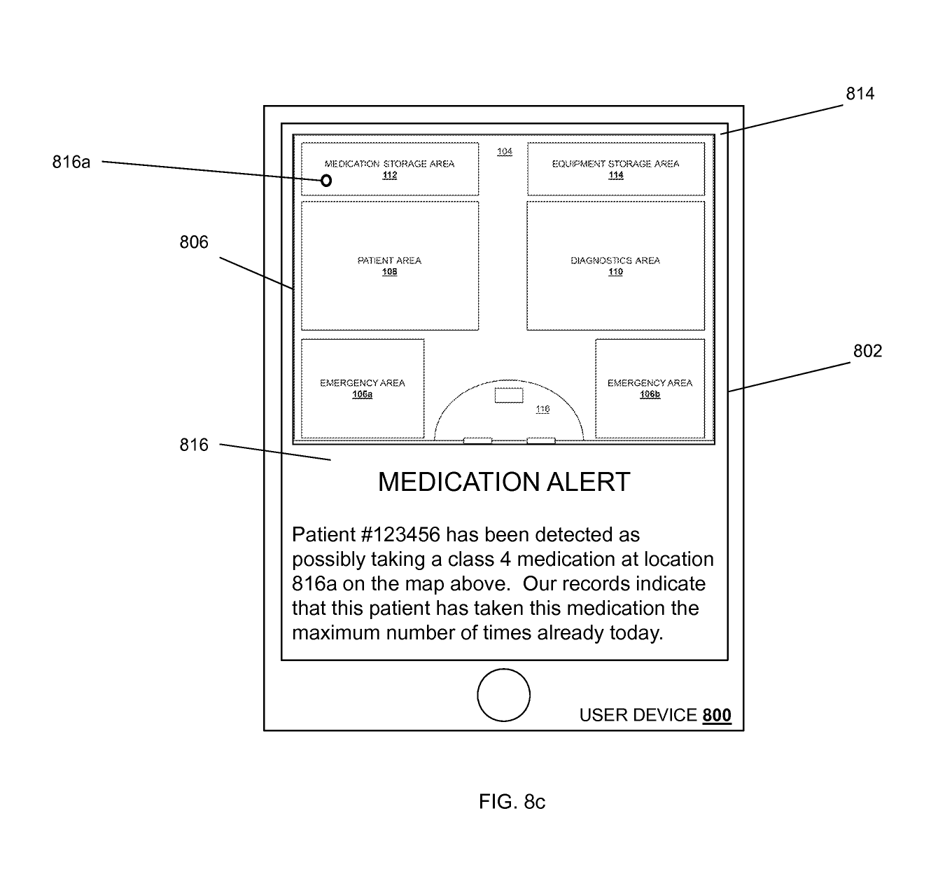

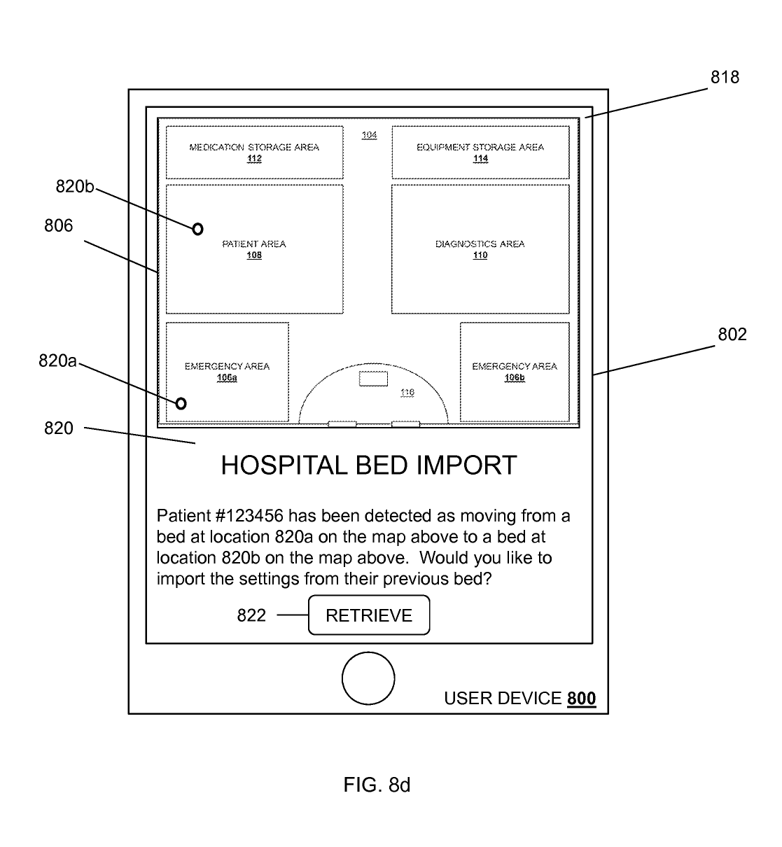

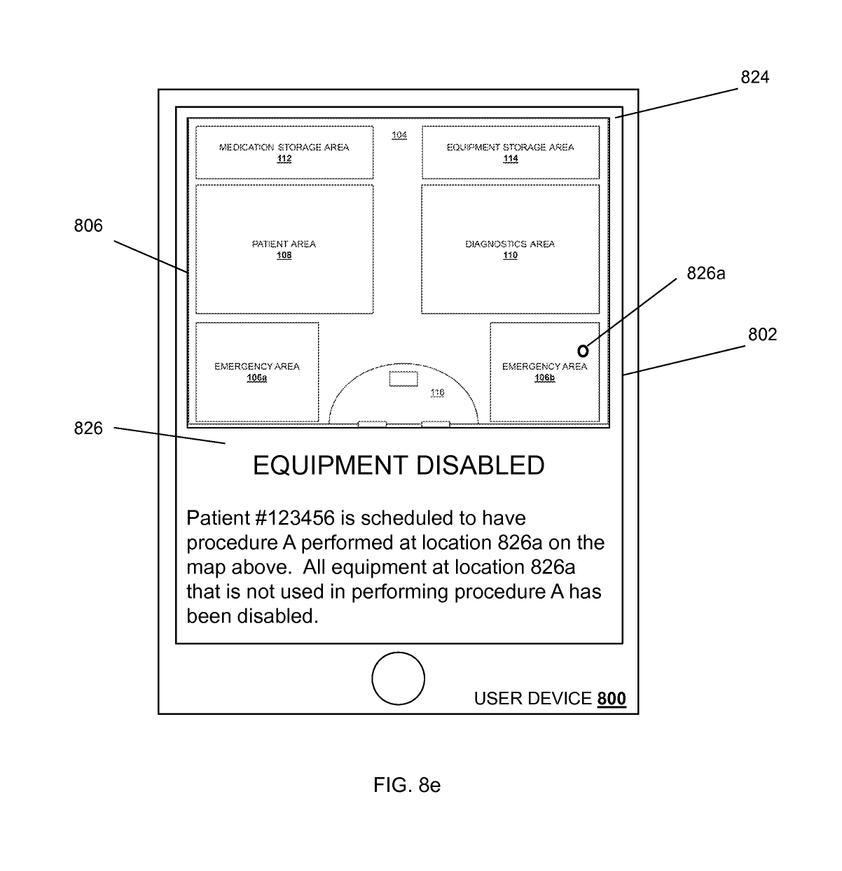

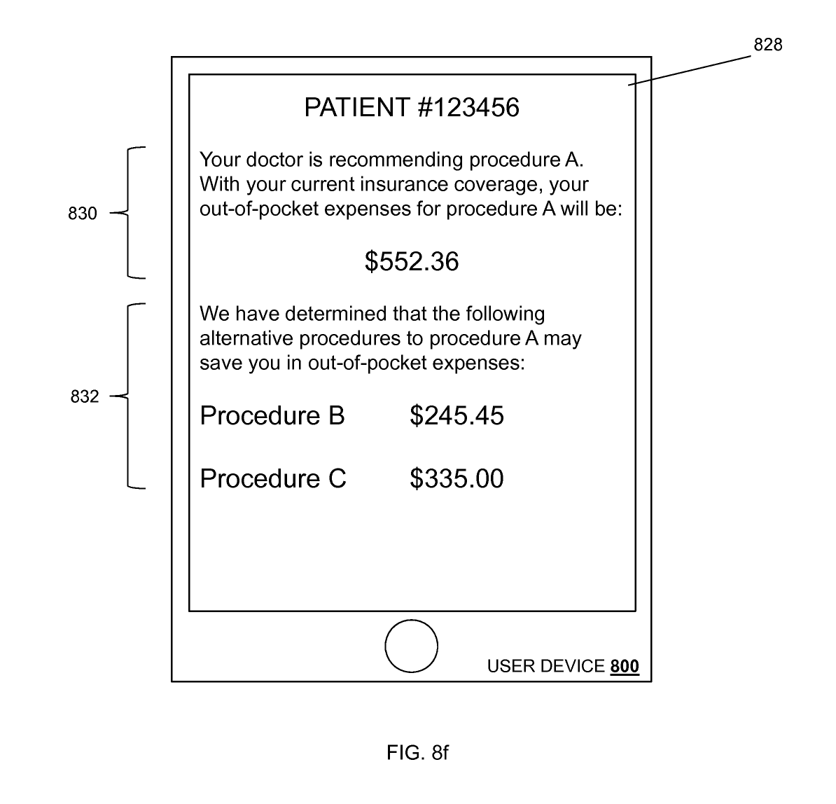

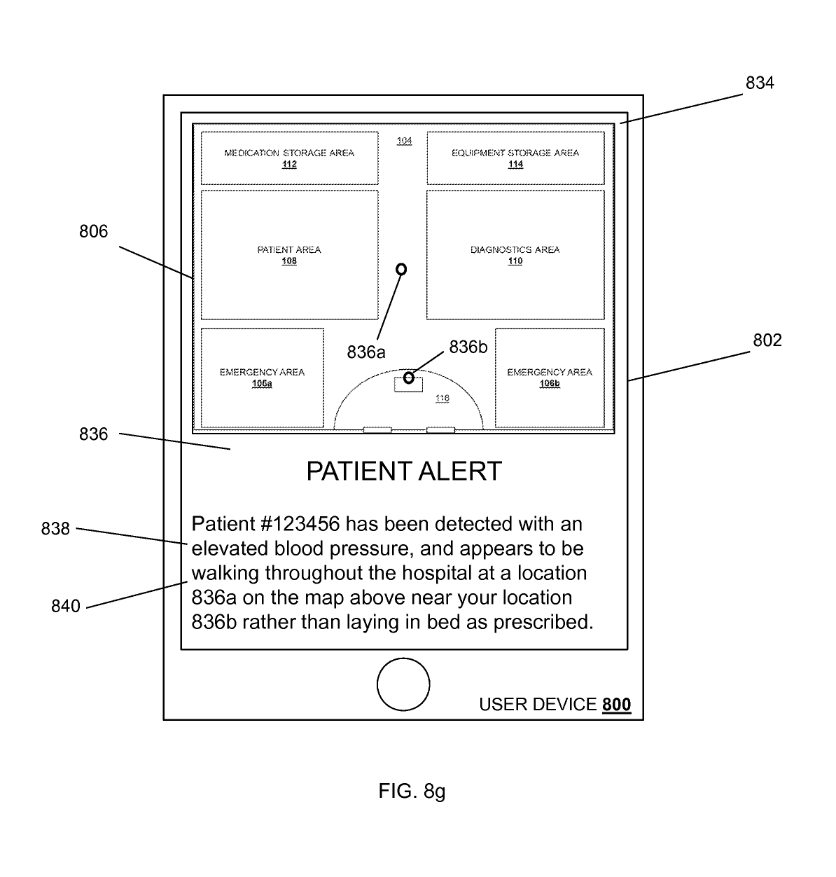

Referring now to FIG. 8a, an embodiment of a user device 800 is illustrated including a display device 802 displaying a management action 804. The management action 804 is provided in response to determining that equipment is being used with a patient that should not be used or co-located with that patient, and includes a map 806 of the physical hospital location 806 and an instruction 808 to not use that equipment with that patient. For example, a doctor or nurse that begins to perform the wrong procedure on a patient may use a piece of equipment that would not be used if the right procedure was being performed, and the hospital asset management system 400 may detect the use of that equipment and a warning provided. As such the management action 804 could be provided to one or more doctors or nurses co-located with the equipment. In some embodiments, equipment that is being used with a patient and should not be may be disabled remotely.

Referring now to FIG. 8b, an embodiment of the user device 800 is illustrated including the display device 802 displaying a management action 810. The management action 810 is provided in response to determining that a first patient and a second patient should not be co-located, and includes the map 806 and instruction 812 to move one of those patients such that the two are no longer co-located. For example, the first patient may have a history of trouble sleeping, while the second patient may have a history of snoring, and if the two patients are moved to the same hospital room, the hospital asset management system 400 may detect that conflict and recommend that the two patients be separated along with a room that one of those patients should be moved to.

Referring now to FIG. 8c, an embodiment of the user device 800 is illustrated including the display device 802 displaying a management action 814. The management action 814 is provided in response to determining that a patient should not be using a medication, and includes the map 806 and an alert 816 to stop the patient from using that medication. For example, a patient may be detected in the medication storage area 112 of the physical merchant location 406, and the hospital asset management system 400 will report that to security personnel at the physical hospital location 406. In another example, a patient may be detected taking medication more that the recommended number of times and the hospital asset management system 400 may report that to a doctor or nurse.

Referring now to FIG. 8d, an embodiment of the user device 800 is illustrated including the display device 802 displaying a management action 818. The management action 818 is provided in response to determining that a patient has been moved to a new hospital bed, and includes the map 806 and provides the user with an instruction 820 and button 822 to retrieve and/or import the settings of the patient's previous hospital bed to the new hospital bed. For example, a settings for a hospital bed (e.g., the hospital bed 600) may be determined for a patient while they are in the emergency area 106a of the physical hospital location 406, and when that patient is moved to a different hospital bed in the patient area 108, those settings may be retrieved and/or imported to the patient's new bed.

Referring now to FIG. 8e, an embodiment of the user device 800 is illustrated including the display device 802 displaying a management action 824. The management action 824 is provided in response to determining that equipment is not authorized for use with a patient or by hospital staff, and includes the map 806 and a notification 826 that equipment has been disabled. For example, a procedure for a patient may be scheduled in an operating room of the physical hospital location 406, and that procedure may require certain surgical instruments. The hospital asset management system 400 may operate to disable any of the equipment in that operating room that is not used for the scheduled procedure by preventing power to that equipment, remotely activating a lock to a container that includes that equipment, or otherwise making that equipment inaccessible or unusable.

Referring now to FIG. 8f, an embodiment of the user device 800 is illustrated including the display device 802 displaying a management action 828. The management action 828 is provided in response to determining an actual cost of the procedure 830 (e.g., an “out-of-pocket” cost) to the patient, as well as possible alternative procedures 832 and their associated cost. For example, a doctor may recommend a procedure for a patient, and hospital asset management system 400 may operate to retrieve the out-of-pocket cost of that procedure for the patient based on their insurance coverage, as well as possible alternative procedures and their associated costs.

Referring now to FIG. 8g, an embodiment of the user device 800 is illustrated including the display device 802 displaying a management action 834. The management action 834 is provided in response to determining monitoring information 838 about a patient of a doctor, along with actions or activities 840 of the patient that are indicative of a problem with the patient. For example, a patient may be prescribed bed rest for ailments that can result in high blood pressure, and if that patient gets out of bed and walks around, both that action/activity and an elevated blood pressure that results may be reported to their doctor or nurse.

Thus, systems and method have been described that provide for the management of a wide variety of hospital assets throughout a physical hospital location using the communication with communication devices provided with those hospital assets. The systems and methods greatly simplify the tracking of hospital assets throughout the physical hospital location, and provide recommendations of management actions related to the managed hospital assets to ensure more efficient and effective running of the hospital.

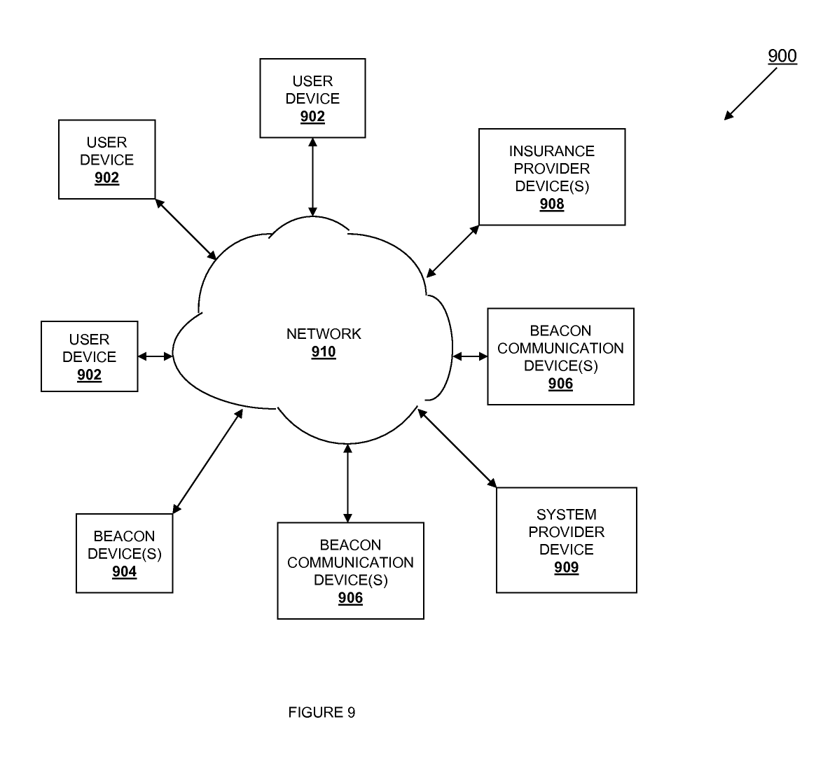

Referring now to FIG. 9, an embodiment of a network-based system 900 for implementing one or more processes described herein is illustrated. As shown, network-based system 900 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 9 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 900 illustrated in FIG. 9 includes a plurality of user devices 902, a plurality of beacon devices 904, a plurality of beacon communication devices 906, a plurality of insurance provider devices 908, and/or a system provider device 909 in communication over a network 910. Any of the user devices 902 may be the user devices discussed above and may be operated by the users (e.g., hospital staff, hospital patients, etc.) discussed above. The plurality of beacon devices 904 may be the beacon devices discussed above and may be operated by the hospitals and/or the system providers discussed above. The beacon communication devices 906 may be the beacon communication devices discussed above and may be operated by the hospitals and/or the system providers discussed above. The insurance provider devices 908 may be the insurance provider devices discussed above and may be operated by the insurance providers discussed above. The system provider device 910 may be the system provider devices discussed above and may be operated by the system providers discussed above.

The user devices 902, beacon devices 904, beacon communication devices 906, insurance provider devices 908, and/or system provider devices 909 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 900, and/or accessible over the network 910.

The network 910 may be implemented as a single network or a combination of multiple networks. For example, in various embodiments, the network 910 may include the Internet and/or one or more intranets, landline networks, wireless networks, and/or other appropriate types of networks.

The user devices 902 may be implemented using any appropriate combination of hardware and/or software configured for wired and/or wireless communication over network 910. For example, in one embodiment, the user devices 902 may be implemented as a personal computer of a user in communication with the Internet. In other embodiments, the user devices 902 may be a smart phone, personal digital assistant (PDA), laptop computer, and/or other types of computing devices.

The user devices 902 may include one or more browser applications which may be used, for example, to provide a convenient interface to permit the user to browse information available over the network 910. For example, in one embodiment, the browser application may be implemented as a web browser configured to view information available over the Internet.

The user devices 902 may also include one or more toolbar applications which may be used, for example, to provide user-side processing for performing desired tasks in response to operations selected by the user. In one embodiment, the toolbar application may display a user interface in connection with the browser application.

The user devices 902 may further include other applications as may be desired in particular embodiments to provide desired features to the user devices 902. In particular, the other applications may include a management application for management assisted by system provider through the system provider device 909. The other applications may also include security applications for implementing user-side security features, programmatic user applications for interfacing with appropriate application programming interfaces (APIs) over the network 910, or other types of applications. Email and/or text applications may also be included, which allow the user to send and receive emails and/or text messages through the network 910. The user devices 902 includes one or more user and/or device identifiers which may be implemented, for example, as operating system registry entries, cookies associated with the browser application, identifiers associated with hardware of the user devices 902, or other appropriate identifiers, such as a phone number. In one embodiment, the user identifier may be used by the system provider device 909 to associate the user with a particular account as further described herein.

The beacon devices 904 and/or beacon communication devices 906 may be maintained, for example, by a hospital or system provider providing for management of hospital assets over the network 910. In this regard, the system provider device 909 may include a database identifying hospital assets and related information for performing the management actions discussed herein.

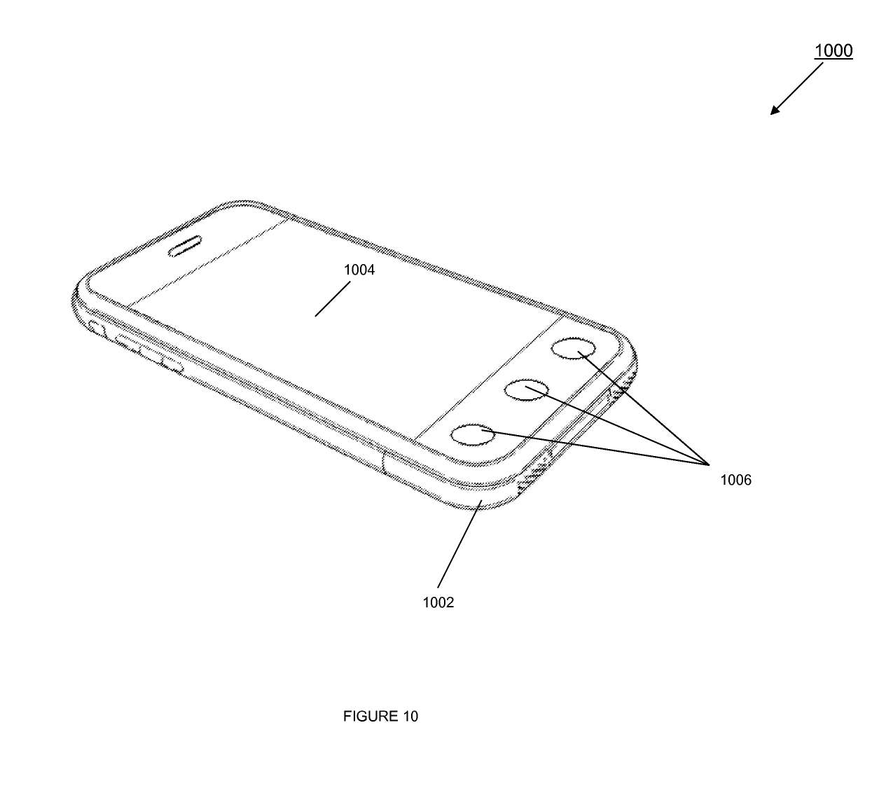

Referring now to FIG. 10, an embodiment of a user device 1000 is illustrated. The user device 1000 may be any of the user devices discussed above. The user device 1000 includes a chassis 1002 having a display 1004 and an input device including the display 1004 and a plurality of input buttons 1006. One of skill in the art will recognize that the user device 1000 is a portable or mobile phone including a touch screen input device and a plurality of input buttons that allow the functionality discussed above with reference to the method 500. However, a variety of other portable/mobile user devices and/or desktop user devices may be used in the method 500 without departing from the scope of the present disclosure.

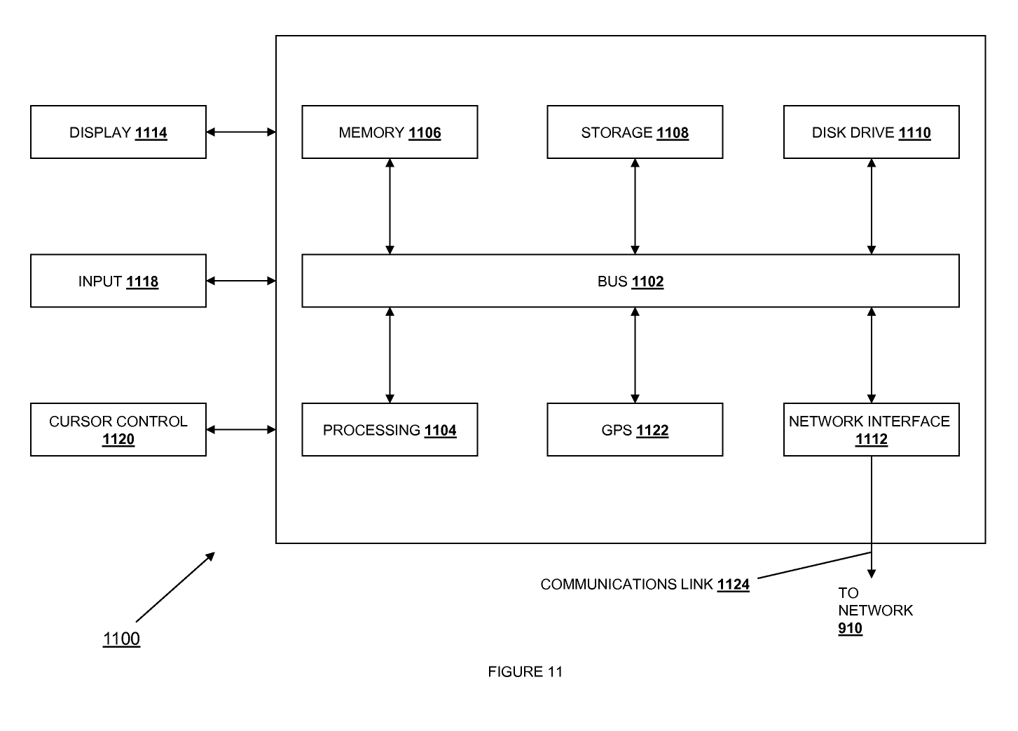

Referring now to FIG. 11, an embodiment of a computer system 1100 suitable for implementing, for example, the user devices 902, beacon devices 904, beacon communication devices 906, insurance provider devices 908, and/or system provider devices 909, is illustrated. It should be appreciated that other devices utilized by users, beacons systems, managed hospital assets, insurance providers, and/or system providers in the hospital asset management system discussed above may be implemented as the computer system 1100 in a manner as follows.

In accordance with various embodiments of the present disclosure, computer system 1100, such as a computer and/or a network server, includes a bus 1102 or other communication mechanism for communicating information, which interconnects subsystems and components, such as a processing component 1104 (e.g., processor, micro-controller, digital signal processor (DSP), etc.), a system memory component 1106 (e.g., RAM), a static storage component 1108 (e.g., ROM), a disk drive component 1110 (e.g., magnetic or optical), a network interface component 1112 (e.g., modem or Ethernet card), a display component 1114 (e.g., CRT or LCD), an input component 1118 (e.g., keyboard, keypad, or virtual keyboard), a cursor control component 1120 (e.g., mouse, pointer, or trackball), and/or a location determination component 1122 (e.g., a Global Positioning System (GPS) device as illustrated, a cell tower triangulation device, and/or a variety of other location determination devices known in the art.) In one implementation, the disk drive component 1110 may comprise a database having one or more disk drive components.

In accordance with embodiments of the present disclosure, the computer system 1100 performs specific operations by the processor 1104 executing one or more sequences of instructions contained in the memory component 806, such as described herein with respect to the user devices 902, beacon devices 904, beacon communication devices 906, insurance provider devices 908, and/or system provider devices 909. Such instructions may be read into the system memory component 1106 from another computer readable medium, such as the static storage component 1108 or the disk drive component 1110. In other embodiments, hard-wired circuitry may be used in place of or in combination with software instructions to implement the present disclosure.

Logic may be encoded in a computer readable medium, which may refer to any medium that participates in providing instructions to the processor 1104 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1110, volatile media includes dynamic memory, such as the system memory component 1106, and transmission media includes coaxial cables, copper wire, and fiber optics, including wires that comprise the bus 1102. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1100. In various other embodiments of the present disclosure, a plurality of the computer systems 1100 coupled by a communication link 1124 to the network 910 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1100 may transmit and receive messages, data, information and instructions, including one or more programs (i.e., application code) through the communication link 1124 and the network interface component 1112. The network interface component 1112 may include an antenna, either separate or integrated, to enable transmission and reception via the communication link 1124. Received program code may be executed by processor 1104 as received and/or stored in disk drive component 1110 or some other non-volatile storage component for execution.

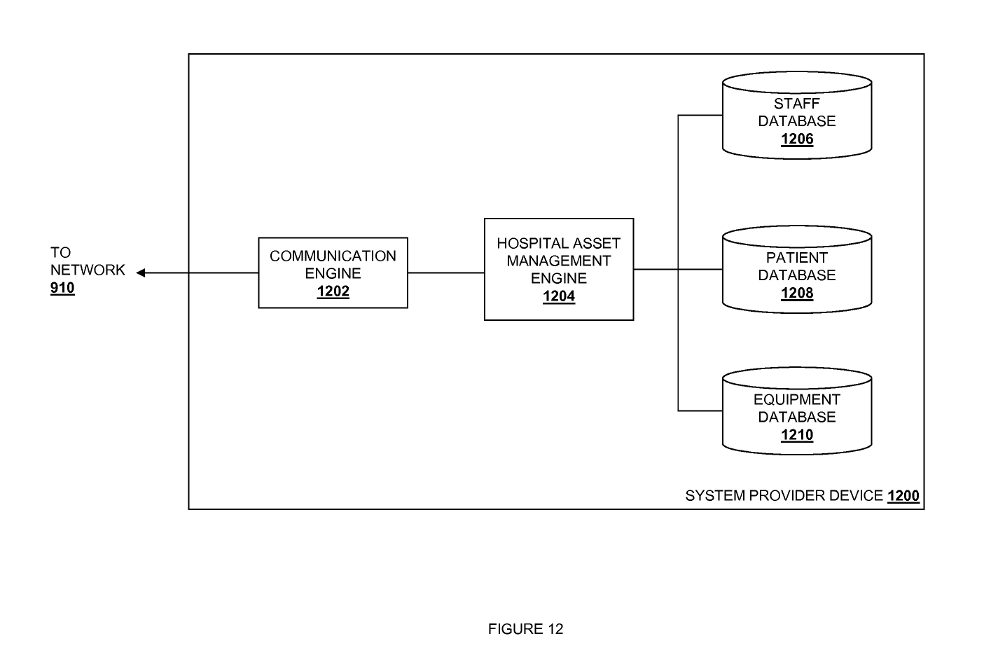

Referring now to FIG. 12, an embodiment of a system provider device 1200 is illustrated. In an embodiment, the device 1200 may be the user devices 902, beacon devices 904, beacon communication devices 906, insurance provider devices 908, and/or system provider devices 909. The device 1200 includes a communication engine 1202 that is coupled to the network 910 and to a hospital asset management engine 1204 that is coupled to a staff database 1206, a patient database 1208, and an equipment database 1210. The communication engine 1202 may be software or instructions stored on a computer-readable medium that allows the device 1200 to send and receive information over the network 910. The hospital asset management engine 1204 may be software or instructions stored on a computer-readable medium that is configured to cause a processing system to receive location information and an identity of managed hospital assets, retrieve hospital asset management information from at least one of the databases 1206, 1208, and/or 1210, transmit the hospital asset management information over a network that is configured to provide a management action, and provide any of the other functionality that is discussed above. While the databases 1206, 1208, and 1210 have been illustrated as separate databases located in the system provider device 1200, one of skill in the art will recognize that they may be combined in to fewer databases, or separated into more database, and/or coupled to the hospital asset management engine 1204 through the network 910 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A shared asset management system, comprising:
a non-transitory memory storing a plurality of shared asset management information;
one or more hardware processors coupled to the memory and configured to read instructions from the memory to perform the steps of:
receiving, through at least one beacon device, an identity of a managed shared asset and a first location information for the managed shared asset that is collected from a beacon communication device that is associated with the managed shared asset;
determining, using the identity of the managed shared asset and the first location information for the managed shared asset, first shared asset management information from the plurality of shared asset management information in the non-transitory memory; and
transmitting the first shared asset management information over a network, wherein the first shared asset management information is configured to provide at least one management action for the managed shared asset.

2. The system of claim 1, wherein the managed shared asset is a managed hospital asset that includes at least one of hospital equipment, a hospital patient, and a hospital staff member.

3. The system of claim 1, wherein the first shared asset management information includes second location information that is different from the first location information and that describes a preferred location for the managed shared asset, and wherein the at least one management action includes an instruction to move the managed shared asset from a first location described by the first location information to the preferred location described by the second location information.

4. The system of claim 1, wherein the first shared asset management information is first hospital asset management information that includes patient information that describes a patient, and wherein the at least one management action includes an indication of whether the managed shared asset may be used with the patient.

5. The system of claim 1, wherein the managed shared asset is a managed hospital asset that includes a hospital bed and the first shared asset management information is first hospital asset management information that includes patient information that describes a patient-specific configuration for the hospital bed.

6. The system of claim 1, wherein the managed shared asset is a managed hospital asset that includes a patient and the first shared asset management information is first hospital asset management information that includes staff information that describes a patient action that is to be performed by at least one hospital staff member.

7. A method for managing shared assets, comprising:
receiving, by a system provider device through at least one beacon device, an identity of a managed shared asset and first location information for the managed shared asset that is collected from a beacon communication device that is associated with the managed shared asset;
determining, by the system provider device using the identity of the managed shared asset and the first location information for the managed shared asset, first shared asset management information from a plurality of shared asset management information that is stored in a database; and
transmitting, by the system provider device, the first shared asset management information over a network, wherein the first shared asset management information is configured to provide at least one management action for the managed shared asset.

8. The method of claim 7, wherein the managed shared asset is a management hospital asset that includes at least one of hospital equipment, a hospital patient, and a hospital staff member.

9. The method of claim 7, wherein the first shared asset management information includes second location information that is different from the first location information and that describes a predetermined location for the managed shared asset.

10. The method of claim 7, wherein the managed shared asset is a managed hospital asset that includes hospital equipment and the first shared asset management information is first hospital asset management information that includes patient information that describes a patient, and wherein the at least one management action includes an indication of whether the hospital equipment may be used with the patient.

11. The method of claim 10, further comprising:
enabling use of the hospital equipment in response to determining that the hospital equipment may be used with the patient; and
disabling use of the hospital equipment in response to determining that the hospital equipment may not be used with the patient.

12. The method of claim 7, wherein the managed shared asset is a managed hospital asset that includes a patient and the first shared asset management information is first hospital asset management information that includes procedure information that describes a procedure that is to be performed by at least one hospital staff member on the patient.

13. The method of claim 7, wherein the managed shared asset is a managed hospital asset that includes a hospital bed and the first shared asset management information is first hospital asset management information that includes patient information that describes a patient-specific configuration for the hospital bed.

14. A non-transitory computer-readable medium comprising instructions which, in response to execution by a computer system, cause the computer system to perform a method comprising:
receiving, through at least one beacon device, an identity of a first managed shared asset and first location information for the first managed shared asset that is collected from a beacon communication device that is associated with the first managed shared asset;
determining, using the identity of the first managed shared asset and the first location information for the first managed shared asset, first shared asset management information from a plurality of shared asset management information in a database; and
transmitting the first shared asset management information over a network, wherein the first shared asset management information is configured to provide at least one management action for the first managed shared asset.

15. The non-transitory machine-readable medium of claim 14, wherein the first managed shared asset is a first managed hospital asset that includes at least one of hospital equipment, a hospital patient, and a hospital staff member.

16. The non-transitory machine-readable medium of claim 15, wherein the method further comprises:
receiving a request for the first managed shared asset, wherein the first location information is received in response to receiving the request.

17. The non-transitory machine-readable medium of claim 14, wherein the first managed shared asset is a first managed hospital asset that includes hospital bed and the first shared asset management information is first hospital asset management information that includes patient information that describes a patient-specific configuration for the hospital bed.

18. The non-transitory machine-readable medium of claim 14, wherein the method further comprises:
storing the identity of the first managed shared asset and the first location information in the database.

19. The non-transitory machine-readable medium of claim 14, wherein the first managed shared asset is a first managed hospital asset that includes a patient and the first shared asset management information is first shared hospital management information that includes staff information that describes a patient action that is to be performed no the patient by at least one hospital staff member.

20. The non-transitory machine-readable medium of claim 14, wherein the method further comprises:
receiving, through at least one beacon device, an identity of a second managed shared asset and second location information for the second managed shared asset that is collected from a beacon communication device that is associated with the second managed shared asset; and
receiving, through at least one beacon device, third location information for the second managed shared asset that is collected from the beacon communication device that is associated with the second managed shared asset, wherein the third location information described a preferred location of the second managed shared asset.
